(19) United States
(12) Patent Application Publication
(10) Pub. No.: US 2026/0212130 A1
(43) Pub. Date: Jul. 23, 2026

(54) Distributed Cognitive Middleware for Human-to-System Mediation and Command Support

(71) Applicant: AtomBeam Technologies Inc., Moraga, CA (US)

(72) Inventor: Brian Galvin, Silverdale, WA (US)

(21) Appl. No.: 19/401,186

(22) Filed: Nov. 25, 2025

Related U.S. Application Data
(63) Continuation-in-part of application No. 19/399,611, filed on Nov. 24, 2025.
Application No. 19/399,611 is a continuation-in-part of application No. 19/397,844, filed on Nov. 21, 2025.
Application No. 19/397,844 is a continuation-in-part of application No. 19/379,579, filed on Nov. 4, 2025.
Application No. 19/379,579 is a continuation-in-part of application No. 19/378,949, filed on Nov. 4, 2025.
Application No. 19/378,949 is a continuation-in-part of application No. 19/377,013, filed on Nov. 2, 2025.
Application No. 19/377,013 is a continuation-in-part of application No. 19/352,457, filed on Oct. 7, 2025.
Application No. 19/352,457 is a continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
Application No. 19/051,193 is a continuation-in-part of application No. 19/038,801, filed on Jan. 28, 2025.
Application No. 19/038,801 is a continuation of application No. 18/818,593, filed on Aug. 29, 2024, now Pat. No. 12,308,862.
Application No. 18/818,593 is a continuation-in-part of application No. 18/657,719, filed on May 7, 2024, now Pat. No. 12,166,506.
Application No. 18/657,719 is a continuation-in-part of application No. 18/410,980, filed on Jan. 11, 2024, now Pat. No. 12,068,761.
Application No. 18/410,980 is a continuation-in-part of application No. 18/537,728, filed on Dec. 12, 2023, now Pat. No. 12,058,333.
Application No. 19/377,013 is a continuation-in-part of application No. 19/326,730, filed on Sep. 12, 2025, now Pat. No. 12,608,555.
Application No. 19/326,730 is a continuation-in-part of application No. 19/321,173, filed on Sep. 6, 2025, now Pat. No. 12,602,549.
Application No. 19/321,173 is a continuation-in-part of application No. 19/245,366, filed on Jun. 22, 2025, now Pat. No. 12,418,680.
Application No. 19/245,366 is a continuation-in-part of application No. 19/204,525, filed on May 10, 2025.
Application No. 19/204,525 is a continuation-in-part of application No. 19/192,215, filed on Apr. 28, 2025.
Application No. 19/192,215 is a continuation-in-part of application No. 18/972,797, filed on Dec. 6, 2024, now Pat. No. 12,294,392.
Application No. 18/972,797 is a continuation-in-part of application No. 18/648,340, filed on Apr. 27, 2024, now Pat. No. 12,166,507.
Application No. 19/378,949 is a continuation-in-part of application No. 19/328,094, filed on Sep. 12, 2025, now Pat. No. 12,632,663.
Application No. 19/328,094 is a continuation-in-part of application No. 19/321,173, filed on Sep. 6, 2025, now Pat. No. 12,602,549.
Application No. 19/379,579 is a continuation-in-part of application No. 19/363,675, filed on Oct. 21, 2025.
Application No. 19/363,675 is a continuation-in-part of application No. 19/351,286, filed on Oct. 6, 2025.
Application No. 19/351,286 is a continuation-in-part of application No. 19/321,173, filed on Sep. 6, 2025, now Pat. No. 12,602,549.
Application No. 19/397,844 is a continuation-in-part of application No. 19/329,330, filed on Sep. 15, 2025.
Application No. 19/329,330 is a continuation-in-part of application No. 19/328,094, filed on Sep. 12, 2025, now Pat. No. 12,632,663.
Application No. 19/397,844 is a continuation-in-part of application No. 19/003,258, filed on Dec. 27, 2024.
Application No. 19/003,258 is a continuation of application No. 18/822,203, filed on Sep. 1, 2024, now Pat. No. 12,229,679.
Application No. 18/822,203 is a continuation-in-part of application No. 18/427,716, filed on Jan. 30, 2024, now Pat. No. 12,093,972.
Application No. 19/399,611 is a continuation-in-part of application No. 19/315,849, filed on Sep. 1, 2025, now Pat. No. 12,572,830.
Application No. 19/315,849 is a continuation-in-part of application No. 19/294,125, filed on Aug. 7, 2025, now Pat. No. 12,579,437.
Application No. 19/294,125 is a continuation-in-part of application No. 19/203,069, filed on Jun. 3, 2025, now Pat. No. 12,481,688.
Application No. 19/203,069 is a continuation-in-part of application No. 19/205,960, filed on May 12, 2025.
Application No. 19/205,960 is a continuation-in-part of application No. 19/060,794, filed on Feb. 24, 2025.
Application No. 19/060,794 is a continuation-in-part of application No. 19/044,546, filed on Feb. 3, 2025.
Application No. 19/044,546 is a continuation-in-part of application No. 19/026,276, filed on Jan. 16, 2025.
Application No. 19/026,276 is a continuation-in-part of application No. 18/928,022, filed on Oct. 26, 2024.
Application No. 18/928,022 is a continuation-in-part of application No. 18/919,417, filed on Oct. 17, 2024, now Pat. No. 12,602,586.
Application No. 18/919,417 is a continuation-in-part of application No. 18/918,077, filed on Oct. 17, 2024.
Application No. 18/918,077 is a continuation-in-part of application No. 18/737,906, filed on Jun. 7, 2024.
Application No. 18/737,906 is a continuation-in-part of application No. 18/736,498, filed on Jun. 6, 2024.
Application No. 19/294,125 is a continuation-in-part of application No. 19/178,873, filed on Apr. 15, 2025, now Pat. No. 12,608,631.
Application No. 19/178,873 is a continuation-in-part of application No. 19/177,611, filed on Apr. 13, 2025, now Pat. No. 12,572,471.
Application No. 19/177,611 is a continuation-in-part of application No. 19/051,193, filed on Feb. 12, 2025, now Pat. No. 12,387,050.
(60) Provisional application No. 63/651,359, filed on May 23, 2024.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/847,969, filed on Jul. 21, 2025.
(60) Provisional application No. 63/847,889, filed on Jul. 21, 2025.

(51) Int. Cl. G06F 40/30; G06F 16/332; G06F 16/3329

(52) U.S. Cl. CPC G06F 40/30; G06F 16/3325; G06F 16/3329

(57) ABSTRACT

A distributed cognitive middleware system enables natural human control of complex distributed computing environments. The system maintains a geometric manifold that represents system commands as nodes in space, with edges showing valid command sequences. When operators provide natural language input, a cognitive mediation engine maps their intent to paths through this command space, finding optimal routes to execute their desired operations. The system remembers successful command patterns, operator preferences, and interaction histories in a distributed cache that can be shared across multiple instances. When familiar patterns are recognized, the system adapts previous solutions to the current context. For novel situations, it synthesizes new command sequences by reasoning through the geometric space. The middleware coordinates command execution across multiple backend systems while keeping all instances synchronized. Individual operator patterns are tracked to personalize future interactions, making complex system control increasingly intuitive over time.

### CROSS-REFERENCE TO RELATED APPLICATIONS

Priority is claimed in the application data sheet to the following patents or patent applications, each of which is expressly incorporated herein by reference in its entirety:
Ser. No. 19/399,611
Ser. No. 19/315,849
Ser. No. 19/294,125
Ser. No. 19/203,069
Ser. No. 19/205,960
Ser. No. 19/060,794
Ser. No. 19/044,546
Ser. No. 19/026,276
Ser. No. 18/928,022
Ser. No. 18/919,417
Ser. No. 18/918,077
Ser. No. 18/737,906
Ser. No. 18/736,498
63/651,359
Ser. No. 19/178,873
Ser. No. 19/177,611
Ser. No. 19/051,193
Ser. No. 19/397,844
Ser. No. 19/379,579
Ser. No. 19/378,949
Ser. No. 19/377,013
Ser. No. 19/352,457
Ser. No. 19/321,173
Ser. No. 19/284,115
63/847,082
63/847,091
63/847,096
63/847,101
63/847,969
Ser. No. 19/038,801
Ser. No. 18/818,593
Ser. No. 18/657,719
Ser. No. 18/410,980
Ser. No. 18/537,728
Ser. No. 19/326,730
63/847,889
Ser. No. 19/245,366
Ser. No. 19/204,525
Ser. No. 19/192,215
Ser. No. 18/972,797
Ser. No. 18/648,340
Ser. No. 19/328,094
Ser. No. 19/363,675
Ser. No. 19/351,286
Ser. No. 19/329,330
Ser. No. 19/003,258
Ser. No. 18/822,203
Ser. No. 18/427,716

### BACKGROUND OF THE INVENTION

### Field of the Art

The present invention relates to the field of artificial intelligence systems for distributed computing environments, and more specifically to persistent cognitive architectures that leverage geometric manifolds and federated learning to enable intuitive human control of complex distributed systems through natural language command interpretation and optimization.

### Discussion of the State of the Art

Current distributed computing environments rely on rigid command-line interfaces, specialized control languages, and domain-specific protocols that require operators to possess deep technical knowledge of each system they control. Traditional command and control systems employ rule-based translation engines that map predefined commands to system operations through static decision trees or lookup tables. These systems lack the ability to understand operator intent beyond literal command syntax, cannot learn from operational patterns, and fail to optimize command execution paths based on historical outcomes. Existing middleware solutions operate as stateless translation layers that process each command independently without maintaining context across sessions or sharing knowledge between distributed instances. When operators work with heterogeneous systems spanning multiple domains—such as coordinating between military command systems, industrial control networks, and emergency response platforms—they must switch between different command syntaxes, mental models, and operational paradigms for each system. Natural language processing systems in current use typically convert speech or text to predefined command sets without understanding the deeper operational intent or considering the geometric relationships between related commands. Furthermore, current systems cannot adapt to individual operator expertise levels, fail to predict likely command sequences, and lack mechanisms for gracefully handling ambiguous or incomplete commands in complex operational scenarios.

The fundamental problem in the art is that existing command and control systems create a cognitive burden on human operators who must translate their operational intent into system-specific commands while mentally tracking dependencies, constraints, and execution paths across multiple distributed systems. This translation burden increases exponentially as systems become more complex and interconnected, leading to operator errors, suboptimal command sequences, and delayed response times in critical situations. Current approaches fail to leverage the geometric relationships inherent in command structures, cannot persistently learn from operator interactions, and lack the distributed cognitive capabilities necessary to maintain consistent understanding across multiple system instances. These limitations become particularly acute in high-stakes environments such as military operations, emergency response, and critical infrastructure management where rapid, accurate command execution across multiple systems can have life-or-death consequences.

What is needed is a distributed cognitive middleware system that maintains a persistent geometric understanding of command relationships, learns from operator interactions across sessions, translates natural human communication into optimized system commands through spatial reasoning, and coordinates execution across heterogeneous distributed systems while adapting to individual operator patterns and expertise levels.

### SUMMARY OF THE INVENTION

Accordingly the inventor has conceived and reduced to practice a distributed cognitive middleware system that revolutionizes how human operators interact with complex distributed computing systems. This innovation creates an intelligent translation and mediation layer that bridges the gap between natural human communication and precise system commands across heterogeneous distributed environments. By combining geometric manifold representations of command relationships with persistent cognitive capabilities that learn from operator interactions, the system enables intuitive control of complex systems through natural language while maintaining the precision and reliability required for critical operations. The middleware architecture fundamentally transforms command-and-control paradigms by introducing spatial reasoning about command relationships, persistent learning of operator patterns, and distributed consensus mechanisms that ensure consistent execution across multiple system endpoints.

In an embodiment, a computer system maintains a latent manifold that serves as a geometric substrate for both cognitive operations and command representation, where system commands exist as nodes in geometric space connected by edges that represent valid command sequences. The system implements a cognitive mediation engine that translates human communication into system commands by mapping natural language intent to geometric trajectories through this command manifold. A distributed thought cache stores cached command patterns, operator interaction histories, and generalized operational knowledge that can be shared across instances. When operators provide input, the system encodes it into latent query trajectories that traverse the manifold to identify optimal command execution paths based on geodesic distance and semantic relationships. The system retrieves and adapts cached command patterns when these query trajectories intersect with established memory basins, preserving operator-specific context and system state during the adaptation. When no cached patterns match, the system synthesizes new command sequences through reasoning models that generate multi-step command chains by traversing the geometric manifold. Throughout operation, the system coordinates command execution across distributed system endpoints while maintaining cognitive state consistency through geometric compression and federated synchronization. The system continuously tracks operator-specific interaction patterns and preferences to personalize command interpretation and response generation across persistent sessions. Based on command execution outcomes, the system updates the latent manifold's structure, strengthening geometric relationships for successful command paths and reconfiguring the manifold when paths fail.

In an aspect of an embodiment, the cognitive mediation engine resolves ambiguous operator commands by computing multiple candidate trajectories through the command manifold and selecting the trajectory with highest confidence based on operator history and current system state.

In an aspect of an embodiment, the system implements distributed consensus mechanisms that ensure command consistency across multiple cognitive instances by synchronizing geometric manifold updates through privacy-preserving transformations.

In an aspect of an embodiment, the command manifold represents temporal dependencies between commands as geometric constraints that prevent invalid command sequences from being executed.

In an aspect of an embodiment, the system adapts command interpretation complexity based on operator expertise levels detected through analysis of historical interaction patterns and command success rates.

In an aspect of an embodiment, failed command executions trigger automatic generation of alternative command paths through the manifold using compression pressure redistribution to avoid overloaded system routes.

In an aspect of an embodiment, the system maintains separate geometric submanifolds for different operational domains that share common command primitives through manifold intersection regions.

In an aspect of an embodiment, the privacy-preserving transformations apply differential geometric operations that preserve command semantic relationships while obscuring operator-specific information.

In an aspect of an embodiment, the system predicts future operator commands by projecting current trajectory momentum through the manifold and pre-caching anticipated command sequences.

In an aspect of an embodiment, the geometric manifold undergoes periodic consolidation during idle states that merges semantically similar command paths and removes deprecated command sequences based on thermodynamic decay principles.

In an embodiment, a computer-implemented method performs the distributed cognitive command mediation operations described in the computer system embodiments above, including maintaining the latent manifold as a geometric substrate for command representation, implementing the cognitive mediation engine for translating human communication to system commands, maintaining the distributed thought cache, encoding operator inputs into query trajectories, retrieving and adapting cached patterns, synthesizing new command sequences, coordinating distributed execution, tracking operator patterns, and updating the manifold based on execution outcomes. The method embodiments include all aspects described for the computer system embodiments, implemented as corresponding method steps.

### BRIEF DESCRIPTION OF THE DRAWING FIGURES

FIG. 1 is a block diagram illustrating an exemplary system architecture of a distributed cognitive middleware platform for human-to-system mediation and command support.

FIG. 2 is a block diagram illustrating an exemplary architecture of a command mediation layer of a distributed cognitive middleware system.

FIG. 3 is a flow diagram illustrating exemplary command translation of a distributed cognitive middleware system.

FIG. 4 is a flow diagram illustrating exemplary distributed execution coordination of a distributed cognitive middleware system.

FIG. 5 is a flow diagram illustrating exemplary learning and adaptation of a distributed cognitive middleware system.

FIG. 6 is a flow diagram illustrating exemplary federation and synchronization of a distributed cognitive middleware system.

FIG. 7 is a flow diagram illustrating exemplary ambiguity resolution of a distributed cognitive middleware system.

FIG. 8 is a flow diagram illustrating exemplary predictive command processing of a distributed cognitive middleware system.

FIG. 9 illustrates an exemplary computing environment on which an embodiment described herein may be implemented.

### DETAILED DESCRIPTION OF THE INVENTION

The inventor has conceived and reduced to practice a distributed cognitive middleware system that bridges human intent with complex machine operations. Instead of requiring operators to memorize rigid command syntax or manage numerous incompatible interfaces, the system interprets natural communication, reasons about intent, and translates that intent into coordinated execution across distributed infrastructures. Over time, the middleware adapts to operator behavior and operational environments, improving efficiency while reducing cognitive workload.

Operator interaction may begin through flexible input channels. A command interface can accept natural language text, spoken instructions, gestures, or graphical inputs. Incoming communication may be normalized into a common representation so that downstream processing is agnostic to modality. Session context and interaction history may be preserved, allowing later instructions to be interpreted with awareness of prior activity. A response interface may deliver outputs such as system status, execution results, clarification requests, or adaptive feedback.

A persistent cognitive core provides the foundation for interpretation and reasoning. This core may include multiple subsystems that cooperate to transform operator input into executable actions. A language subsystem may parse input and generate context-aware responses, while a reasoning subsystem may assemble inference chains that connect incomplete or ambiguous instructions to concrete operational goals. An executive subsystem may coordinate these processes and maintain continuity of state across sessions or deployments.

A cognitive dynamics engine represents operator intent geometrically. Instructions may be expressed as trajectories through a latent manifold where commands are represented as nodes and valid sequences appear as paths connecting them. Distances and directions within this manifold may capture semantic relationships. Properties such as curvature or compression fields may influence how trajectories form, guiding operators toward efficient solutions and away from invalid or overloaded regions. This geometric representation allows the system to optimize command paths and discover new relationships through iterative use.

Memory and persistence mechanisms support continuity and learning. A thought cache may store prior command trajectories, execution outcomes, and contextual data, enabling reuse and adaptation of successful patterns. A persistence layer may maintain cognitive state across sessions or process restarts. During idle periods, a consolidation process may merge related entries, abstract stable patterns, and prune obsolete data. A relationship model may track operator preferences, expertise levels, and interaction histories, allowing responses to be adapted to individual styles and proficiency levels.

Translation of cognitive intent into concrete execution may occur in a mediation layer. This layer may convert trajectories into system-specific commands, apply validation rules, and sequence operations for distribution across multiple infrastructures. An execution coordination component may analyze dependencies, evaluate system conditions, and manage distributed transactions with rollback and recovery strategies. A response analysis component may evaluate results, detect anomalies, and initiate updates to memory or manifold structures. Adapters within this layer may provide protocol translation, authentication management, and reliable communication with heterogeneous systems. A federation controller may enable distributed instances to share knowledge through privacy-preserving transformations and consensus protocols, enhancing adaptability while protecting operator information.

Operational environments connected through this middleware may include military platforms, industrial control systems, enterprise IT infrastructures, or emergency response systems. Middleware instances may interact with such environments through adapters that handle protocol-specific communication and enforce security requirements. Execution results may be monitored and routed back through the mediation layer, forming a closed loop in which outcomes directly influence subsequent cognitive adaptation.

The architecture may further provide mechanisms for resolving ambiguity and anticipating future commands. When operator input contains multiple interpretations, the system may generate alternative trajectories, evaluate them using operator history and system conditions, and either select the most confident option or request clarification. Predictive functions may project operator trajectories forward through the manifold, pre-caching likely commands to reduce latency. Successes may reinforce predictive pathways, while errors may adjust calculation parameters to improve future accuracy.

In larger deployments, multiple middleware instances may cooperate through federation. Instances may identify knowledge suitable for sharing, transform it using privacy-preserving techniques such as differential privacy or geometric projection, and exchange it with peers. Updates may be merged through consensus protocols, allowing manifold structures to evolve consistently across distributed systems. This process allows local systems to retain autonomy while benefiting from shared operational experience.

By combining natural language processing, geometric reasoning, adaptive memory, predictive processing, and federated synchronization, this distributed cognitive middleware provides a flexible framework for human-to-system mediation. Operators may issue intuitive instructions, and the system interprets, optimizes, and executes them across diverse infrastructures. Through continued use, the system adapts to operator behavior and evolving environments, supporting more effective management of complex distributed operations.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “latent manifold” refers to a geometric representation of command and control relationships within a multidimensional space. In some embodiments, commands may be represented as nodes, and valid sequences as paths connecting those nodes. Distances or directions within the manifold can reflect semantic similarity, operational dependency, or temporal ordering, and properties such as curvature, compression fields, or attractor regions may influence traversal.

As used herein, “cognitive dynamics engine” refers to a subsystem that interprets operator intent as a trajectory through a latent manifold. This trajectory may be shaped by semantic input, operator history, or system conditions. The engine can compute optimal command paths, generate alternative trajectories, or project future operator actions.

As used herein, “thought cache” refers to a memory structure that stores prior command trajectories, operator interactions, and execution outcomes. Cached trajectories may be reused when similar inputs are encountered, and may evolve over time through processes such as consolidation, decay, or reinforcement. The cache can include memory local to a single instance or federated structures shared across distributed systems.

As used herein, “persistence layer” refers to mechanisms that maintain continuity of state across sessions, processes, or hardware cycles. Persistence may involve checkpointing, state serialization, or recovery routines. In some embodiments, persistence allows operator context and cognitive state to be restored after interruption.

As used herein, “sleep manager” refers to a subsystem that consolidates or reorganizes memory during periods of reduced activity. Functions may include merging related trajectories, pruning obsolete patterns, or abstracting generalized knowledge.

As used herein, “relationship model” refers to data structures and processes that track operator-specific characteristics such as expertise, preferences, historical patterns, or authorization levels. The model may influence how commands are interpreted, how responses are generated, and how confidence thresholds are applied.

As used herein, “command mediation layer” refers to components that transform cognitive trajectories into executable operations for heterogeneous backend systems. This layer can include translation of commands into protocol-specific formats, coordination of distributed transactions, evaluation of outcomes, and synchronization of knowledge across federated instances.

As used herein, “compression pressure” refers to a measure of resource load or semantic density within a portion of the latent manifold. In some embodiments, compression pressure may be estimated as a ratio between command arrival rate and processing capacity. High compression pressure may indicate congested regions and can trigger rerouting or reconfiguration.

As used herein, “federation controller” refers to components that manage synchronization of knowledge among multiple middleware instances. A federation controller may apply privacy-preserving transformations, exchange knowledge signatures, evaluate similarity, and implement distributed consensus. Federation allows distributed systems to share operational experience while retaining local autonomy.

As used herein, “backend systems” refers to external infrastructures that execute commands translated and coordinated by the middleware. Examples include, but are not limited to, military platforms, industrial control environments, enterprise IT infrastructures, or emergency response networks.

As used herein, “trajectory momentum” refers to an estimation of operator navigation direction and speed within a latent manifold. In some embodiments, momentum may be represented by velocity vectors describing rate of movement and direction vectors describing tendency toward particular command clusters.

As used herein, “cache hit” refers to a condition in which an actual operator command aligns with a command previously predicted and prepared by the system. A cache hit may allow immediate execution of a pre-cached command, reducing latency relative to normal translation.

As used herein, “anticipatory path” refers to a projected trajectory generated by extending current operator movement through a latent manifold. Anticipatory paths may be used to pre-identify likely future commands, allocate resources in advance, or prepare command templates for rapid execution.

As used herein, “ambiguity resolution” refers to processes for handling operator inputs that support multiple interpretations, contain incomplete parameters, or exhibit conflicting semantics. Resolution may involve generating candidate trajectories, applying operator history, evaluating system constraints, ranking alternatives, and either selecting a preferred interpretation or requesting clarification from the operator.

### Conceptual Architecture of a Distributed Cognitive Middleware Platform for Human-PCM System Mediation and Command Support

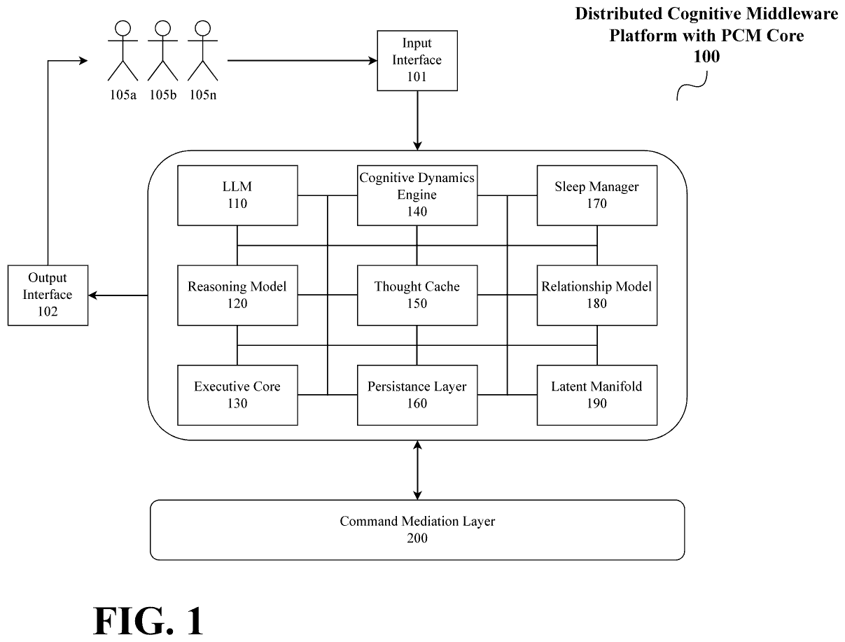

FIG. 1 is a block diagram illustrating an exemplary system architecture of a distributed cognitive middleware platform 100 for human-to-system mediation and command support. In an embodiment, platform 100 translates operator intent into distributed commands by projecting multi-modal input into a latent manifold maintained and operated upon by a cognitive dynamics engine 140, computing trajectories through that manifold that correspond to executable command sequences, and coordinating execution across heterogeneous backend systems while maintaining a persistent cognitive state.

Human operators 105a-n may interact with platform 100 through a command input interface 101, which may receive natural language, voice, gesture, or graphical inputs. Interface 101 may perform validation and normalization of the input, preserve session context, and forward structured queries into a persistent cognitive machine (PCM) core while maintaining interaction history across multiple sessions.

The PCM core may comprise several integrated subsystems operating in concert. A language model 110 may parse and generate natural language content. A reasoning model 120 may apply multi-step inference and intent analysis to processed input. An executive core 130 may orchestrate the functions of the subsystems and maintain state continuity. A cognitive dynamics engine (CDE) 140 may perform geometric operations within a latent manifold by treating operator intent as a trajectory-finding process. In this geometric representation, commands may be encoded as nodes and valid sequences represented as paths between those nodes. Traversal may be influenced by conceptual fields, such as a kinetic-effort measure representing change required to move between command states, a compression-pressure field representing semantic density of regions that become more difficult to traverse when overloaded, and a goal-potential field that pulls trajectories toward regions aligned with operator intent and system objectives.

A thought cache 150 may store and retrieve previously executed command paths and related cognitive artifacts. The cache may organize trajectories as basins that attract similar future queries. When an operator input corresponds to a cached trajectory, the system may reinstate that path and adapt it to the current operator state and prevailing system conditions. Cached trajectories may have associated activation energies that decay if unused so that frequently accessed sequences persist while obsolete ones are pruned. When no cached sequence matches current intent, reasoning model 120 may generate new command chains by traversing the manifold under the guidance of CDE 140 and assembling valid paths that satisfy system dependencies. In operation, data flows through system 100 as follows. Human operators 105a-n provide multi-modal inputs through command input interface 101, which normalizes and forwards structured queries into the persistent cognitive machine (PCM) core. Executive core 130 orchestrates subsystem engagement, directing language model 110 and reasoning model 120 to parse and analyze operator intent. Cognitive dynamics engine 140 projects this intent into latent manifold 190, where trajectories are computed across geometric structures shaped by semantic fields, compression pressure, and goal potentials. Thought cache 150 is consulted to retrieve or adapt previously successful command paths, while persistence layer 160 ensures continuity of state across sessions. Relationship model 180 adjusts interpretation granularity based on operator profiles. Resulting trajectories are conveyed into command mediation layer 200, where command translation 210 generates system-specific syntax, execution coordinator 220 selects optimized distributed paths, response analyzer 230 evaluates outcomes, system adapters 240 interface with backend targets 260, and federation controller 250 synchronizes knowledge across distributed instances. Execution results flow back through the mediation layer into the PCM core for learning updates, and formatted responses are delivered to operators through response output interface 102, completing a closed loop of adaptive, persistent cognition.

A persistence layer 160 may maintain cognitive state across restarts by serializing and restoring subsystem state, cache indices, and manifold-related parameters. In an embodiment, persistence layer 160 may provide checkpointing and recovery controls to ensure continuity of cognition for platform 100 independent of power cycles or process migration.

During idle periods, a sleep manager 170 may perform offline consolidation. The sleep manager may perturb cached bundles stochastically to test stability; variations that remain coherent may be retained as generalized abstractions, while unstable or redundant ones may be pruned. In certain embodiments, thermodynamic-style decay parameters may be adjusted during these periods to regulate cache density and manifold simplification.

A relationship model 180 may track individual operator profiles, authorization levels, interaction histories, and preferences. Using these relationships, the PCM core may adapt explanation granularity, vocabulary, and decision thresholds based on detected expertise and past outcomes.

In an embodiment, system 100 further comprises a latent manifold 190, which may serve as the geometric substrate upon which cognitive operations occur. Unlike static embedding spaces in conventional systems, latent manifold 190 may function as a dynamic and evolving geometry that continuously adapts through operator interactions, cache consolidation, and federated synchronization. Within this manifold, cognitive content may exist not as isolated points but as structured regions such as compact submanifolds representing coherent concepts, geodesic trajectories corresponding to chains of inference and association, and continuous semantic fields indicating distributions of meaning and relevance.

Latent manifold 190 may maintain geometric structures including, for example, a metric tensor defining local semantic distances, a connection governing parallel transport of attention, curvature measures indicating regions of semantic compression or sparsity, compression pressure fields derived from curvature, goal potential fields that bias trajectories toward target outcomes, and attention vector fields describing instantaneous cognitive flow. The cognitive dynamics engine 140 may read from and reshape these geometric structures in real time, while connections to thought cache 150, persistence layer 160, and relationship model 180 may facilitate the embedding, storage, adaptation, and retrieval of semantic content.

As system 100 operates, latent manifold 190 may exhibit emergent topological features such as attractor basins where frequently accessed concepts stabilize, high-curvature regions corresponding to semantic density, low-pressure corridors that enable efficient inference, and bridge structures connecting previously disparate domains. Through iterative use, manifold 190 may evolve a personalized geography reflecting operator patterns, domain structure, and accumulated cognitive histories.

Outputs of the PCM core may be conveyed to a command mediation layer 200, which includes specialized components to bridge intent to executable operations. A command translation subsystem 210 may map PCM trajectories to system-specific command syntax and protocols. An execution coordinator 220 may select distributed execution paths, resolve dependencies, manage rollback, and schedule operations while avoiding overloaded regions inferred via compression-pressure signals. A response analyzer 230 may classify outcomes, compute performance metrics, and generate learning triggers for cache and manifold updates. System adapters 240 may provide protocol translation, authentication, and system-specific error handling for heterogeneous backends. A federation controller 250 may synchronize knowledge among distributed PCM instances using privacy-preserving transformations and distributed consensus to ensure consistent interpretation and execution.

Feedback from backend target systems 260 (e.g., military command platforms, industrial control networks, enterprise IT infrastructure, or emergency response systems) may be returned through command mediation layer 200 to the PCM core for evaluation and learning and then formatted for the operator via a response output interface 102. Through this architecture, operator intent may be mapped into executable trajectories, mediated by geometric cognition, optimized across distributed infrastructures, and continuously improved by persistent memory, adaptive learning, and federated synchronization.

In operation, data may flow through system 100 as follows. Human operators 105a-n provide multi-modal inputs through command input interface 101, which normalizes and forwards structured queries into the persistent cognitive machine (PCM) core. Executive core 130 orchestrates subsystem engagement, directing language model 110 and reasoning model 120 to parse and analyze operator intent. Cognitive dynamics engine 140 projects this intent into latent manifold 190, where trajectories are computed across geometric structures shaped by semantic fields, compression pressure, and goal potentials. Thought cache 150 is consulted to retrieve or adapt previously successful command paths, while persistence layer 160 ensures continuity of state across sessions. Relationship model 180 adjusts interpretation granularity based on operator profiles. Resulting trajectories are conveyed into command mediation layer 200, where command translation 210 generates system-specific syntax, execution coordinator 220 selects optimized distributed paths, response analyzer 230 evaluates outcomes, system adapters 240 interface with backend targets 260, and federation controller 250 synchronizes knowledge across distributed instances. Execution results flow back through the mediation layer into the PCM core for learning updates, and formatted responses are delivered to operators through response output interface 102, completing a closed loop of adaptive, persistent cognition.

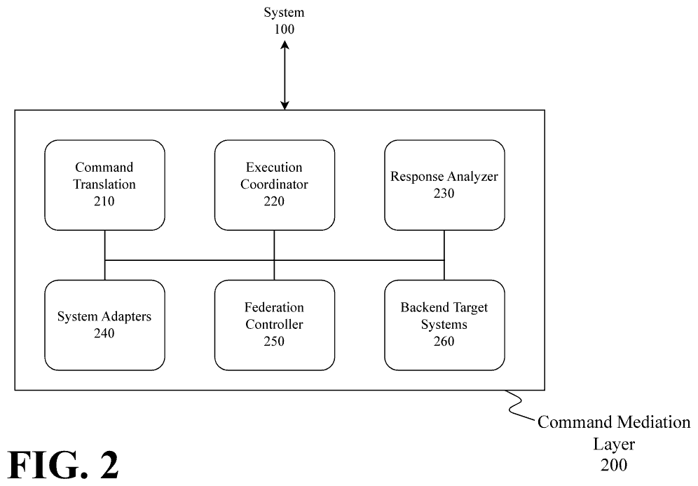

FIG. 2 is a block diagram illustrating an exemplary architecture of a command mediation layer 200 of a distributed cognitive middleware system 100, in an embodiment. Command mediation layer 200 functions as an intelligent bridge between cognitive processing performed by persistent cognitive machine core components and heterogeneous backend target systems 260. Command mediation layer 200 translates abstract command trajectories computed through latent manifold 190 into executable system operations while maintaining bidirectional feedback to support continuous learning and adaptation.

Command translation subsystem 210 receives trajectory outputs from cognitive dynamics engine 140 representing operator intent encoded as paths through latent manifold 190. In some embodiments, each trajectory output includes a sequence of coordinate vectors in a latent space having dimensionality suitable for the operational context (for example, hundreds or thousands of dimensions), with optional annotations such as semantic labels and confidence scores. Command translation subsystem 210 maintains a registry of command templates indexed by manifold regions. Each template may be implemented as a parameterized structure containing fields such as syntax patterns, parameter specifications, value constraints, and target system identifiers. For example, a template for database operations may reference SQL patterns with placeholders for table names and conditions. Templates may be identified through techniques such as nearest-neighbor search, cosine similarity, or clustering, and instantiated by mapping trajectory parameters to placeholders, performing type conversions, applying format transformations, and encoding outputs into system-specific protocols such as JSON or binary formats.

Execution coordinator 220 receives translated commands from command translation subsystem 210 and orchestrates their distribution across backend target systems 260. Execution coordinator 220 analyzes command dependencies by referencing geometric constraints encoded in latent manifold 190. For example, temporal dependencies may be represented as directed edges with timing annotations, while logical dependencies may be represented by regions of manifold curvature. Compression pressure may be estimated as a function of command arrival rates and processing capacity, and threshold conditions may trigger rerouting. Execution coordinator 220 implements routing strategies such as weighted round-robin, least-connections, or adaptive reinforcement learning methods. It maintains transaction contexts using data structures that track command sequences and rollback points, and in some embodiments may implement distributed commit protocols such as two-phase commit.

In an embodiment, compression pressure provides a metric for system load that execution coordinator 220 uses to guide routing decisions. For example, compression pressure may be computed as a ratio of command arrival rate to processing capacity, such as P=λ/μ where λ represents commands per second arriving at a particular execution path and μrepresents the path's maximum throughput capacity. Alternative formulations may incorporate additional factors such as queue depth, response time degradation, or resource utilization percentages. When compression pressure exceeds configurable thresholds, such as 0.7 for warning conditions or 0.9 for critical conditions, execution coordinator 220 initiates rerouting procedures that redirect command flows through alternative manifold trajectories having lower pressure values. These pressure calculations may be performed continuously, periodically, or triggered by specific events, with the computation method selected based on system characteristics and performance requirements.

Response analyzer 230 processes outcomes returned from backend target systems 260 through system adapters 240. In an embodiment, response analyzer 230 classifies results using methods such as rule-based classifiers, decision trees, support vector machines, or neural networks. Performance metrics may be computed over configurable time windows, such as moving averages or exponentially weighted moving averages. Deviations from expected baselines may generate learning triggers that update thought cache 150 (for example, by adjusting edge weights in a command graph or inserting new trajectory-outcome pairs) and relationship model 180 (for example, by refining operator skill profiles or preference vectors).

System adapters 240 provide protocol-specific interfaces to backend target systems 260. Adapters implement authentication mechanisms, which may include token exchange for web services, ticket-based protocols for enterprise systems, or certificate-based authentication for industrial protocols. Adapters manage connections using pooling mechanisms with configurable parameters such as pool sizes and timeout values, and track state transitions such as connecting, authenticating, and connected. Adapters translate between internal command representations and external APIs through transformation pipelines that may include field mapping, type conversion, protocol framing, and serialization into formats such as Protocol Buffers or MessagePack. Error handling may involve retry policies, exponential backoff strategies, circuit breakers, or resource isolation techniques.

Federation controller 250 manages knowledge synchronization across distributed instances of system 100. In an embodiment, synchronization may be performed using protocols such as gossip exchanges, consensus algorithms including Raft or Byzantine-fault-tolerant methods, or vector clock techniques for causal ordering. Federation controller 250 includes privacy-preserving transformations to protect operator-specific data, which may include differential privacy, homomorphic encryption, secure multi-party computation, or geometric operations such as random rotations or dimensional projections within the manifold space. Federation controller 250 evaluates similarity of shared patterns using metrics such as Jaccard similarity, edit distance, or geodesic distance within the manifold. These mechanisms ensure distributed consistency while maintaining local autonomy and protecting sensitive information.

Backend target systems 260 represent the heterogeneous platforms and infrastructures with which command mediation layer 200 interacts. These systems receive translated and coordinated commands through system adapters 240 and return execution results for analysis and learning. In various embodiments, backend target systems 260 may include, for example, military command-and-control platforms, industrial control networks, enterprise IT infrastructure, or emergency response systems. Each backend target system 260 operates using its own native protocols, authentication mechanisms, and execution semantics, which are abstracted and normalized by the system adapters 240.

In operation, backend target systems 260 provide execution outcomes, status reports, and error signals that are conveyed back through command mediation layer 200 for processing by response analyzer 230. These feedback signals support continuous adaptation of latent manifold 190, updates to thought cache 150, and adjustments to relationship model 180. By maintaining compatibility with diverse backend environments, backend target systems 260 enable distributed cognitive middleware system 100 to apply its cognitive mediation capabilities across multiple domains while preserving system-specific precision.

During operation in an embodiment, command mediation layer 200 receives trajectory outputs from cognitive dynamics engine 140 and transforms them into executable actions across backend target systems 260. Command translation subsystem 210 maps abstract trajectories into system-specific command structures, which execution coordinator 220 sequences and routes according to dependencies and load conditions. Response analyzer 230 processes outcomes from backend target systems 260, generating feedback that updates persistent memory and operator models. System adapters 240 provide the necessary protocol translations and authentication to interact with diverse backend infrastructures, while federation controller 250 synchronizes evolving knowledge across distributed instances to maintain consistency and adaptability. Through this coordinated process, command mediation layer 200 ensures that operator intent, expressed through latent manifold 190, is executed reliably and efficiently in heterogeneous distributed environments while supporting continuous learning and personalization.

As an illustrative example of command mediation layer 200 operation, consider an operator providing a natural language instruction such as “restart the backup database server” to command input interface 101. After processing by language model 110 and reasoning model 120, cognitive dynamics engine 140 generates a trajectory through latent manifold 190 that terminates at a node representing database restart operations. Command translation subsystem 210 receives this trajectory, identifies a database management template through similarity matching, and instantiates it with parameters extracted from the trajectory, producing a system-specific command such as a REST API call with JSON payload. Execution coordinator 220 evaluates dependencies, determining that active transactions must complete before restart, and queues the command accordingly. When execution proceeds, system adapters 240 authenticate with the database management system, submit the restart command, and receive a response indicating successful initiation. Response analyzer 230 processes this outcome, classifying it as successful and updating thought cache 150 to strengthen this command path for future use. Meanwhile, federation controller 250 may share this successful pattern with peer instances, applying privacy-preserving transformations to protect operator-specific details while preserving the general command structure for reuse across the distributed deployment.

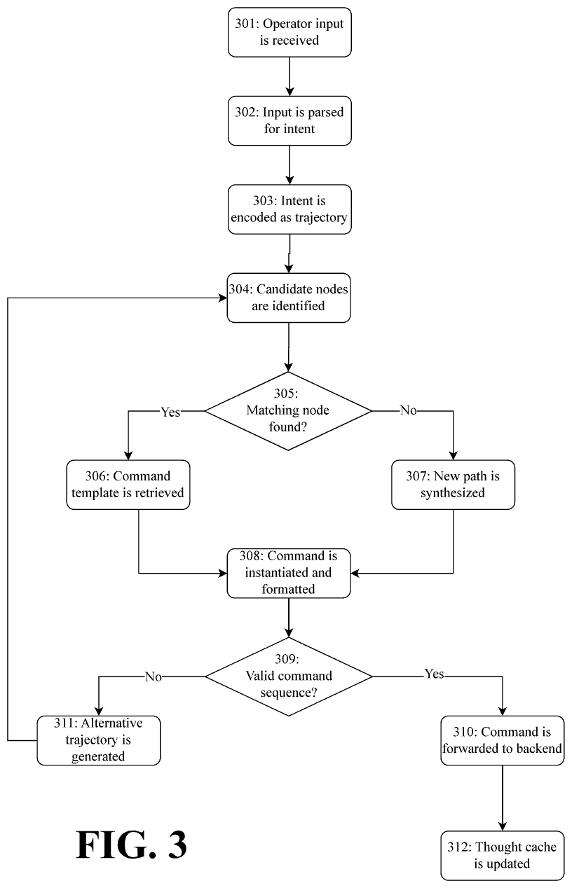

FIG. 3 is a flow diagram illustrating exemplary command translation of a distributed cognitive middleware system 100, in an embodiment. Command translation begins when command input interface 101 receives operator input from human operators 105a-n. Input may comprise, for example, natural language text, spoken voice commands, gesture inputs, or graphical interface interactions 301.

The input is processed by language model 110, which parses the received content to extract semantic elements, operational intent, and relevant parameters while preserving contextual information from the active session 302.

Parsed intent is then provided to cognitive dynamics engine 140, which encodes the content into a query trajectory by mapping semantic elements to coordinates within latent manifold 190 303. In some embodiments, the trajectory may be represented as a vector path through the manifold, where distance and orientation reflect semantic relationships.

The query trajectory is compared against existing manifold regions by cognitive dynamics engine 140, which computes similarity metrics such as geodesic distance or semantic correlation to identify candidate command nodes 304.

A determination step evaluates whether identified candidates meet minimum thresholds for confidence and proximity 305.

When a suitable match exists, command translation subsystem 210 retrieves an associated command template from the matched manifold node 306. Templates may include syntax patterns, parameter specifications, and target system identifiers.

When no adequate match is found, reasoning model 120 synthesizes a new command path by traversing latent manifold 190 through intermediate nodes, generating a valid command sequence based on geometric constraints and semantic relationships 307.

Once a template is retrieved or a new path synthesized, command translation subsystem 210 instantiates the command 308. This instantiation may include mapping trajectory parameters to template placeholders, performing type conversions, and applying formatting rules suitable for target protocols. The instantiated command sequence is validated by execution coordinator 220, which checks temporal dependencies, parameter constraints, and compatibility with current system state 309.

Validated commands are forwarded by execution coordinator 220 to backend target systems 260 for distributed execution 310. When validation fails, cognitive dynamics engine 140 generates an alternative trajectory by adjusting search parameters or exploring different manifold regions, avoiding previously failed paths 311.

Upon successful translation and forwarding, thought cache 150 records the resulting trajectory-to-command mapping 312. This update preserves the translation pattern for future reuse, enabling faster and more reliable recognition of similar operator inputs in subsequent sessions.

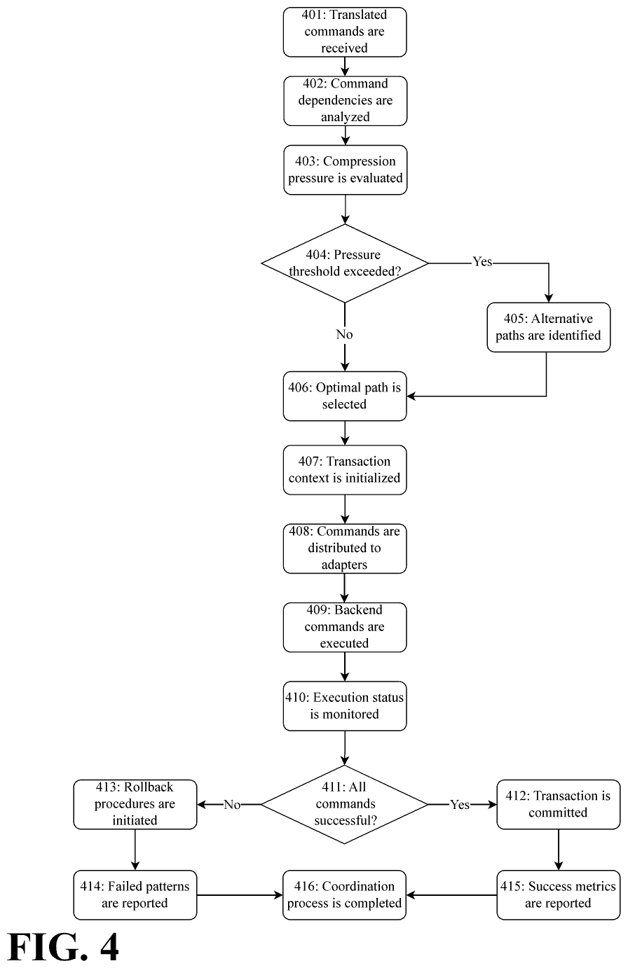

FIG. 4 is a flow diagram illustrating exemplary distributed execution coordination of a distributed cognitive middleware system 100, in an embodiment.

Execution coordinator 220 receives translated commands from command translation subsystem 210, containing system-specific syntax and target system identifiers 401. Execution coordinator 220 analyzes command dependencies by constructing dependency structures such as directed acyclic graphs, where nodes represent individual commands and edges encode temporal, logical, or resource-based dependencies derived from geometric constraints in latent manifold 190 402.

Compression pressure is evaluated for each potential execution path 403. In some embodiments, compression pressure may be estimated as the ratio of command arrival rate λ to processing capacity μ, where pressure P=λ/μ. Threshold values are compared to determine whether calculated pressure exceeds configurable limits 404. For example, values around 0.7 may be treated as warning conditions and values around 0.9 as critical overload conditions.

When pressure thresholds are exceeded, execution coordinator 220 identifies alternative execution paths 405. In an embodiment, alternative trajectories may be located by querying latent manifold 190 for paths with lower compression pressure values while maintaining semantic equivalence. Execution coordinator 220 selects an optimal execution path 406. Selection criteria may include compression pressure, geodesic distance, resource availability, and historical success rates retrieved from thought cache 150.

Execution coordinator 220 initializes a transaction context 407. Initialization may include creating rollback points, storing current system state, and establishing coordination tokens for distributed transaction management. Commands are then distributed to system adapters 240 408. System adapters 240 handle protocol translation, authentication, and connection management for respective backend target systems 260.

Backend target systems 260 execute the received commands 409. Execution occurs according to native protocols, while system adapters 240 maintain execution handles and monitor progress. Execution coordinator 220 monitors execution status 410 by polling system adapters 240 for completion states, tracking timeouts, and detecting error conditions across participating backend systems.

A completion check evaluates whether all distributed commands have successfully executed within timeout constraints and without error conditions 411. When all commands complete successfully, execution coordinator 220 commits the distributed transaction 412. Commitment may include sending commit signals to all participating system adapters 240 and releasing transaction resources.

When any command fails, execution coordinator 220 initiates rollback procedures 413. Rollback may involve reversing completed operations in reverse dependency order and restoring system state from saved rollback points. Failed execution patterns are reported to response analyzer 230 414. Reports may include failure causes, affected systems, and rollback actions taken. Successful execution metrics are also reported to response analyzer 230 415. Metrics may include completion times, resource utilization, and performance indicators for strengthening successful paths in latent manifold 190.

The distributed execution coordination completes when all commands have been processed, transactions finalized, and execution outcomes reported for cognitive learning updates 416.

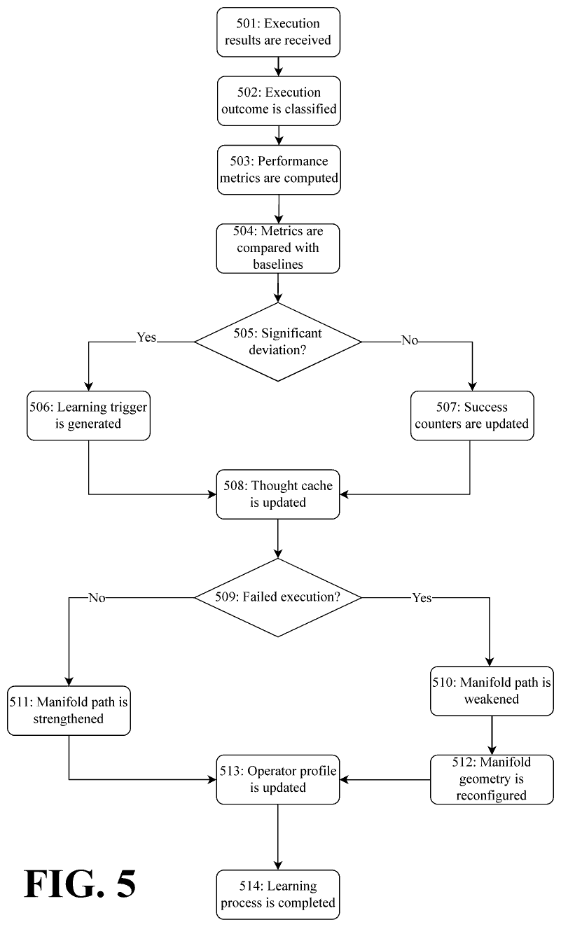

FIG. 5 is a flow diagram illustrating exemplary learning and adaptation of a distributed cognitive middleware system 100, in an embodiment.

Response analyzer 230 receives execution results from execution coordinator 220, containing outcome data, performance metrics, and system responses from backend target systems 260 501. Response analyzer 230 classifies the execution outcome 502. Categories may include, for example, complete success, partial success, recoverable failure, or critical failure, and classification may be performed according to predefined rules and outcome patterns.

Performance metrics are computed 503. In some embodiments, these metrics may include execution latency, throughput rates, resource utilization percentages, and error frequencies, calculated over configurable time windows using aggregation methods such as moving averages or exponentially weighted calculations. Response analyzer 230 compares computed metrics against historical baselines retrieved from thought cache 150 504. Comparisons may involve calculating deviation percentages and identifying statistical anomalies.

A deviation assessment determines whether the difference between current metrics and historical baselines exceeds configured significance thresholds 505. When significant deviations are detected, response analyzer 230 generates a learning trigger 506. In an embodiment, such triggers may mark the execution pattern for adaptation and initiate updates to one or more cognitive components. When deviations remain within normal ranges, the system updates success counters in thought cache 150 507. Updates may include incrementing frequency counts and adjusting confidence scores for the executed command path.

Thought cache 150 receives updates 508. Updates may include execution patterns, outcome classifications, and performance metrics, which are stored as new trajectory-outcome pairs or applied to existing cache entries. A failure evaluation examines whether the execution resulted in any condition requiring manifold reconfiguration 509.

For failed executions, cognitive dynamics engine 140 weakens the corresponding manifold path 510. In some embodiments, weakening may include reducing edge weights between command nodes or increasing traversal resistance for future queries. For successful executions, cognitive dynamics engine 140 strengthens the manifold path 511. Strengthening may involve, for example, increasing edge weights, reducing geodesic distances, or creating stronger attractor basins for similar future queries.

Failed paths trigger manifold reconfiguration 512. Cognitive dynamics engine 140 may adjust local geometry by modifying curvature values, redistributing compression pressure, or creating bypass routes around problematic regions. Relationship model 180 updates the operator profile 513. Updates may include recording command success rates, adjusting expertise-level assessments, and refining preference vectors based on execution outcomes.

The learning and adaptation process completes when all cognitive components have been updated 514, ensuring that future command processing benefits from accumulated operational experience.

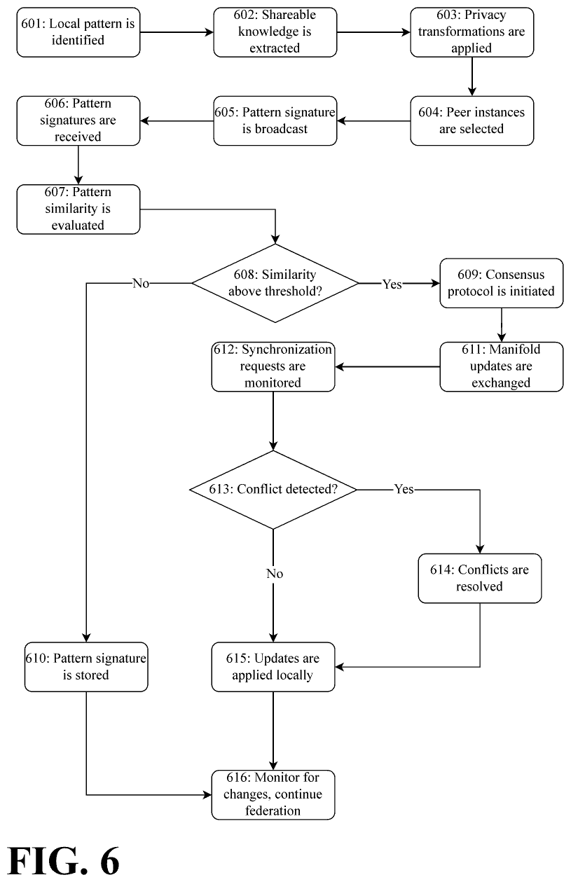

FIG. 6 is a flow diagram illustrating exemplary federation and synchronization of a distributed cognitive middleware system 100, in an embodiment.

Federation controller 250 identifies a local pattern in thought cache 150 that meets criteria for cross-instance sharing 601. Criteria may include, for example, frequently successful command sequences or newly discovered optimization paths. Federation controller 250 extracts shareable knowledge 602 by removing operator-specific identifiers, personal preferences, and sensitive system details while preserving the geometric structure and semantic relationships of the pattern.

Privacy-preserving transformations are applied 603. In some embodiments, such transformations may include differential geometric operations such as random rotations in manifold space, dimensional projections, or homomorphic encryption that maintain pattern utility while obscuring origin information. Federation controller 250 selects peer instances for synchronization 604. Peer selection may consider federation topology, network proximity, trust levels, and relevance scores maintained in a distributed registry.

The system broadcasts a pattern signature 605. Signatures may include compressed geometric descriptors, semantic hashes, and metadata, which are transmitted to selected peer instances through secure communication channels. Federation controller 250 receives pattern signatures from other instances 606 and queues them for similarity evaluation and potential integration into the local cognitive state.

Pattern similarity is evaluated 607. In some embodiments, this may involve computing geodesic distances between received patterns and local manifold structures, using metrics such as Frechet distance or Hausdorff distance in the latent space. A similarity assessment determines whether computed values fall below a configurable threshold 608, indicating sufficient relevance for synchronization.

When similarity exceeds the threshold, federation controller 250 initiates a consensus protocol 609. In various embodiments, this may include protocols such as Raft or Byzantine fault-tolerant methods to coordinate manifold updates across participating instances. When similarity remains below the threshold, the system stores the pattern signature in local cache 610. Stored signatures may be referenced in future cycles, with acceptance thresholds adjusted if similar patterns arrive from multiple peers.

Participating instances exchange detailed manifold updates 611. Updates may include node additions, edge weight modifications, curvature adjustments, or compression pressure redistributions through the consensus protocol. Federation controller 250 monitors for additional synchronization requests 612. Monitoring may include handling pattern updates from peers, tracking changes in federation topology, and maintaining heartbeat signals with connected instances.

Conflict detection identifies inconsistencies between local and received manifold updates 613. Detected conflicts may include contradictory edge weights or incompatible geometric constraints. When conflicts are detected, federation controller 250 resolves them 614. Resolution may use configurable merge rules such as timestamp priority, authority weighting, or voting mechanisms among participating instances.

Synchronized updates are applied to local manifold 190 615. Updates may also involve thought cache 150 and relationship model 180, with changes implemented while maintaining local operational consistency. The federation cycle completes when all synchronization operations have been processed, conflicts resolved, and the local instance returns to monitoring state for subsequent federation opportunities 616.

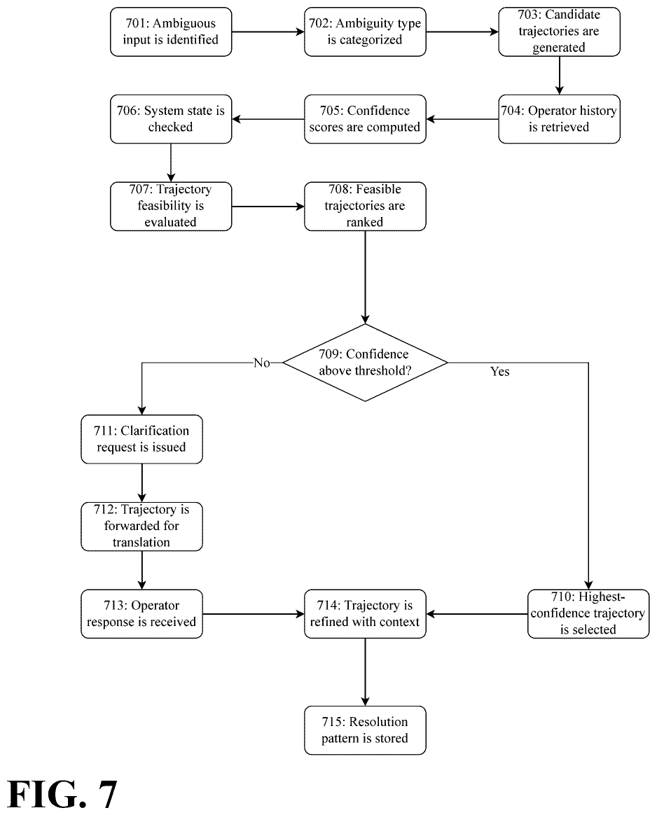

FIG. 7 is a flow diagram illustrating exemplary ambiguity resolution of a distributed cognitive middleware system 100, in an embodiment.

The cognitive mediation engine identifies an ambiguous operator input 701. Ambiguity may arise from multiple valid interpretations, incomplete parameters, or conflicting semantic elements that prevent direct command translation. The system identifies the ambiguity type 702. Categories may include, for example, semantic ambiguity involving multiple word meanings, syntactic ambiguity from grammatical structure, or contextual ambiguity requiring session history for resolution.

Cognitive dynamics engine 140 generates multiple candidate trajectories 703. Each trajectory represents a different plausible interpretation of the operator's intent mapped to distinct command paths within latent manifold 190. Relationship model 180 retrieves the operator's interaction history 704. Retrieved information may include previous command patterns, preference vectors, expertise indicators, and recent session context from persistent storage.

Each candidate trajectory receives a confidence score 705. In some embodiments, scores may be computed from historical pattern matches, frequency of similar past commands, and alignment with operator-specific preferences stored in relationship model 180. Executive core 130 checks current system state 706. Such checks may involve querying backend target systems 260 for resource availability, active processes, security constraints, or operational modes affecting command feasibility.

The system evaluates trajectory feasibility 707. Feasibility assessment may include verifying that each candidate path satisfies system constraints, respects current permissions, and remains executable given available resources and active state. Cognitive mediation engine ranks feasible trajectories 708. Ranking may be based on a combination of confidence scores, system state compatibility, and geometric proximity in the manifold.

A confidence assessment determines whether the highest-ranked trajectory exceeds a configurable threshold 709. When confidence exceeds the threshold, cognitive mediation engine selects the highest-confidence trajectory 710 and may mark alternative trajectories for potential fallback use. When confidence remains below the threshold, response output interface 102 requests clarification from the operator 711. In some embodiments, clarification may include presenting ambiguity details and suggesting specific information needed for resolution.

The selected trajectory is forwarded to command translation subsystem 210 712. Forwarding triggers the standard translation process into system-specific commands. When clarification is requested, command input interface 101 receives the operator's response 713. Responses may include additional context, parameter specifications, or explicit selection among presented options.

Cognitive dynamics engine 140 refines the trajectory 714. Refinement may involve incorporating new information, adjusting path parameters, and recalculating confidence scores with the added context. The ambiguity resolution completes when a single high-confidence trajectory has been identified and forwarded for execution 715. In some embodiments, the resolution pattern is also stored in thought cache 150 for future reference.

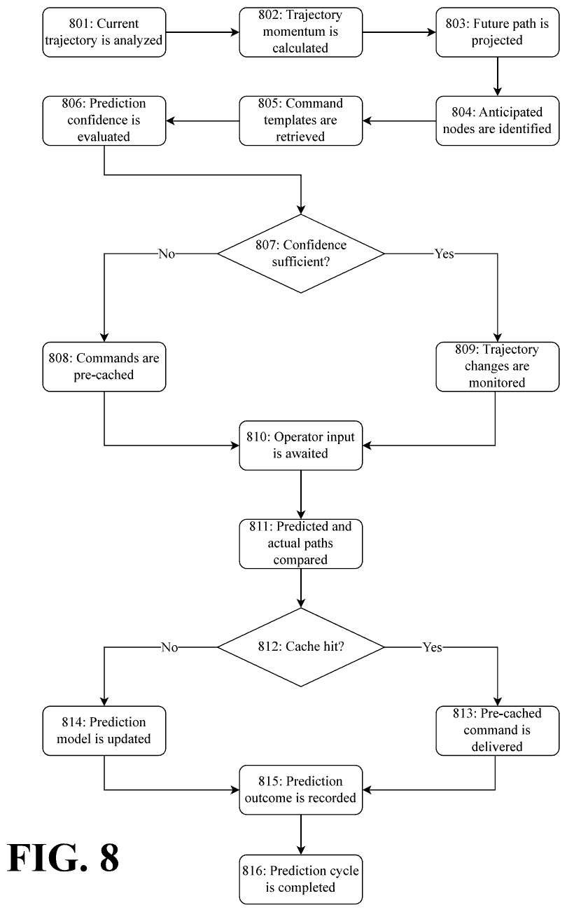

FIG. 8 is a flow diagram illustrating exemplary predictive command processing of a distributed cognitive middleware system 100, in an embodiment.

Cognitive dynamics engine 140 analyzes the current trajectory of operator interactions through latent manifold 190 801. Analysis may include examining recent command sequences and navigation patterns through the geometric space. The system calculates trajectory momentum 802. In some embodiments, momentum may be represented by velocity vectors indicating rate of movement through manifold regions and direction vectors indicating navigational tendencies toward specific command clusters.

Cognitive dynamics engine 140 projects the future path 803. Projection may extend the current trajectory forward through the manifold using momentum calculations, geometric constraints, and historical trajectory patterns retrieved from thought cache 150. The system identifies anticipated command nodes 804. Anticipated nodes may lie along the projected path within a configurable lookahead distance, with selection based on highest probability of traversal as indicated by trajectory alignment.

Command translation subsystem 210 retrieves command templates associated with anticipated nodes 805. Templates may include syntax patterns, parameter specifications, and system identifiers for potential execution. The system evaluates prediction confidence 806. Confidence analysis may consider path stability metrics such as trajectory variance, historical consistency of similar paths, and strength of momentum indicators in the current navigation pattern.

A confidence assessment determines whether calculated prediction confidence exceeds minimum thresholds for pre-caching operations 807. When confidence is sufficient, thought cache 150 pre-caches anticipated commands 808. Pre-caching may include storing instantiated templates, pre-computed parameters, or pre-authenticated connections in high-speed memory for rapid retrieval. When confidence is insufficient, the system continues monitoring trajectory changes without committing resources to pre-caching 809, maintaining observation of operator navigation patterns for emerging predictability.

The system waits for actual operator input 810. During this waiting period, pre-cached commands may be maintained in ready state while elapsed time since prediction generation is tracked. Upon receiving operator input, cognitive dynamics engine 140 compares the actual command request to the predicted trajectory 811. Comparison may involve calculating similarity measures between predicted and actual paths through the manifold.

A cache hit determination evaluates whether the actual operator command matches any pre-cached prediction 812. Similarity thresholds may be configurable to balance responsiveness with accuracy. When a cache hit occurs, execution coordinator 220 delivers the pre-cached command immediately 813. This may bypass normal translation latency and provide accelerated operator response. When no cache hit occurs, the system updates its prediction model 814. Updates may involve adjusting momentum calculation parameters, modifying lookahead distances, or refining pattern recognition algorithms based on prediction error.

Relationship model 180 records the prediction outcome 815. Updates may include adjusting success rates, modifying operator-specific prediction parameters, or strengthening and weakening pattern associations within the manifold. The prediction cycle completes when the outcome has been recorded and prediction models updated 816, with successful predictions reinforcing anticipatory patterns and failures triggering algorithmic adjustments.

### Exemplary Computing Environment

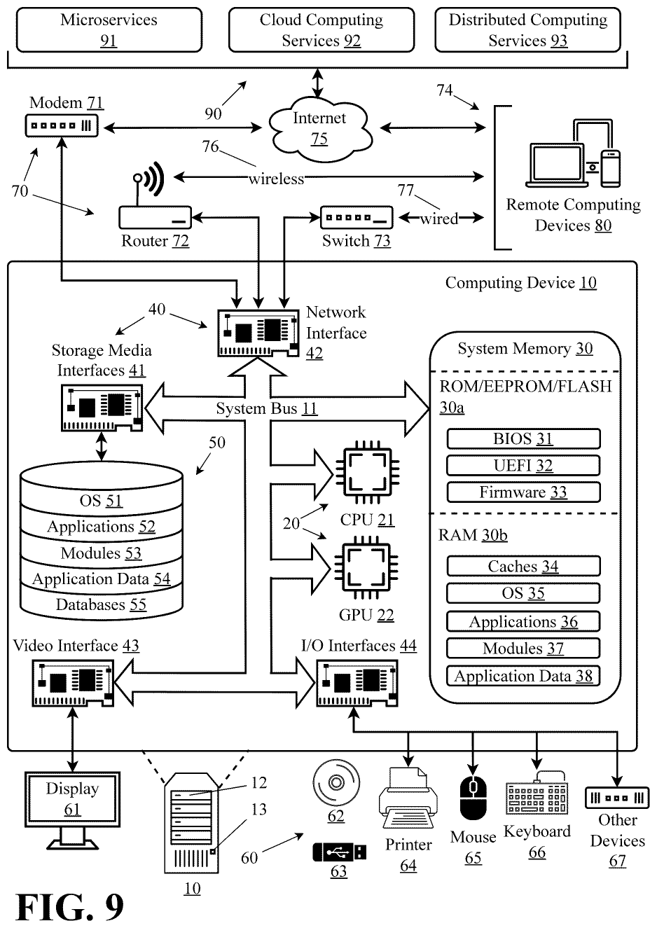

FIG. 9 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising a hardware memory, wherein the computer system is configured to execute software instructions stored on nontransitory machine-readable storage media that:
maintain a latent manifold as a geometric substrate for cognitive operations and command representation, wherein the latent manifold encodes system commands as nodes in geometric space with edges representing valid command sequences;
implement a cognitive mediation engine that translates human communication into system commands by mapping natural language intent to geometric trajectories through the command manifold;
maintain a distributed thought cache comprising cached command patterns, operator interaction histories, and generalized operational knowledge suitable for cross-instance sharing;
encode operator inputs into latent query trajectories that traverse the manifold to identify optimal command execution paths based on geodesic distance and semantic relationships;
retrieve and adapt cached command patterns when query trajectories intersect established memory basins, wherein the adaptation preserves operator-specific context and system state;
synthesize new command sequences through reasoning models when no cached patterns match, wherein the reasoning models generate multi-step command chains by traversing the geometric manifold;
coordinate command execution across distributed system endpoints while maintaining cognitive state consistency through geometric compression and federated synchronization;
track operator-specific interaction patterns and preferences to personalize command interpretation and response generation across persistent sessions; and
update the latent manifold's structure based on command execution outcomes, wherein successful command paths strengthen corresponding geometric relationships and failed paths trigger manifold reconfiguration.

2. The computer system of claim 1, wherein the cognitive mediation engine resolves ambiguous operator commands by computing multiple candidate trajectories through the command manifold and selecting the trajectory with highest confidence based on operator history and current system state.

3. The computer system of claim 1, wherein the system implements distributed consensus mechanisms that ensure command consistency across multiple cognitive instances by synchronizing geometric manifold updates through privacy-preserving transformations.

4. The computer system of claim 1, wherein the command manifold represents temporal dependencies between commands as geometric constraints that prevent invalid command sequences from being executed.

5. The computer system of claim 1, wherein the system adapts command interpretation complexity based on operator expertise levels detected through analysis of historical interaction patterns and command success rates.

6. The computer system of claim 1, wherein failed command executions trigger automatic generation of alternative command paths through the manifold using compression pressure redistribution to avoid overloaded system routes.

7. The computer system of claim 1, wherein the system maintains separate geometric submanifolds for different operational domains that share common command primitives through manifold intersection regions.

8. The computer system of claim 3, wherein the privacy-preserving transformations apply differential geometric operations that preserve command semantic relationships while obscuring operator-specific information.

9. The computer system of claim 1, wherein the system predicts future operator commands by projecting current trajectory momentum through the manifold and pre-caching anticipated command sequences.

10. The computer system of claim 1, wherein the geometric manifold undergoes periodic consolidation during idle states that merges semantically similar command paths and removes deprecated command sequences based on thermodynamic decay principles.

11. A computer-implemented method for distributed cognitive command mediation, comprising:
maintaining a latent manifold as a geometric substrate for cognitive operations and command representation, wherein the latent manifold encodes system commands as nodes in geometric space with edges representing valid command sequences;
implementing a cognitive mediation engine that translates human communication into system commands by mapping natural language intent to geometric trajectories through the command manifold;
maintaining a distributed thought cache comprising cached command patterns, operator interaction histories, and generalized operational knowledge suitable for cross-instance sharing;
encoding operator inputs into latent query trajectories that traverse the manifold to identify optimal command execution paths based on geodesic distance and semantic relationships;
retrieving and adapting cached command patterns when query trajectories intersect established memory basins, wherein the adaptation preserves operator-specific context and system state;
synthesizing new command sequences through reasoning models when no cached patterns match, wherein the reasoning models generate multi-step command chains by traversing the geometric manifold;
coordinating command execution across distributed system endpoints while maintaining cognitive state consistency through geometric compression and federated synchronization;
tracking operator-specific interaction patterns and preferences to personalize command interpretation and response generation across persistent sessions; and
updating the latent manifold's structure based on command execution outcomes, wherein successful command paths strengthen corresponding geometric relationships and failed paths trigger manifold reconfiguration.

12. The method of claim 11, wherein the cognitive mediation engine resolves ambiguous operator commands by computing multiple candidate trajectories through the command manifold and selecting the trajectory with highest confidence based on operator history and current system state.

13. The method of claim 11, further comprising implementing distributed consensus mechanisms that ensure command consistency across multiple cognitive instances by synchronizing geometric manifold updates through privacy-preserving transformations.

14. The method of claim 11, wherein the command manifold represents temporal dependencies between commands as geometric constraints that prevent invalid command sequences from being executed.

15. The method of claim 11, further comprising adapting command interpretation complexity based on operator expertise levels detected through analysis of historical interaction patterns and command success rates.

16. The method of claim 11, wherein failed command executions trigger automatic generation of alternative command paths through the manifold using compression pressure redistribution to avoid overloaded system routes.

17. The method of claim 11, further comprising maintaining separate geometric submanifolds for different operational domains that share common command primitives through manifold intersection regions.

18. The method of claim 13, wherein the privacy-preserving transformations apply differential geometric operations that preserve command semantic relationships while obscuring operator-specific information.

19. The method of claim 11, further comprising predicting future operator commands by projecting current trajectory momentum through the manifold and pre-caching anticipated command sequences.

20. The method of claim 11, wherein the geometric manifold undergoes periodic consolidation during idle states that merges semantically similar command paths and removes deprecated command sequences based on thermodynamic decay principles.
